(19) United States
(12) Patent Application Publication
(10) Pub. No.: US 2007/0076664 A1
(43) Pub. Date: Apr. 5, 2007

(54) Handoff decision making for heterogeneous network environments

(76) Inventors: Yafan An, Fremont, CA (US); Allan Baw, San Jose, CA (US); Mark Gallagher, Newbury (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/242,367

(22) Filed: Sep. 30, 2005

(51) Int. Cl. H04Q 7/00

(52) U.S. Cl. 370/331; 370/328; 370/352

(57) ABSTRACT

A method and apparatus of handoff decision making for heterogeneous network environments are described. In one embodiment, the method includes receiving session initiation protocol (SIP) messages from a mobile device via a wireless local area network (WLAN). The SIP messages contain data identifying at least one current network characteristic. The method further includes determining whether a handoff trigger for the mobile device is detected using the current network characteristic.

### FIELD OF THE INVENTION

The present invention relates to wireless communications; more particularly, the present invention relates to management of mobility events between heterogeneous network environments.

### BACKGROUND OF THE INVENTION

Wireless Local Area Networks (WLANs) provide users with high-speed wireless Internet access and an inexpensive alternative to telephone services as well as other real-time applications. The users can carry a mobile device with dual-use capability so that the mobile device can provide voice and data communication over a WLAN when the mobile device is in the WLAN (in a coverage area and registered with the WLAN) and over a cellular wide area network (cellular network) when the mobile device is outside of the WLAN.

When the user is moving between different networks such as, for example, from a WLAN to a cellular network, the user expects to experience a seamless switch between the WLAN and the cellular network, even during an ongoing Internet session. However, current inter-technology handoff techniques have failed to provide such seamless capability to the users.

### SUMMARY OF THE INVENTION

A method and apparatus of handoff decision making for heterogeneous network environments are described.

According to one aspect, the method includes receiving session initiation protocol (SIP) messages from a mobile device via a wireless local area network (WLAN). The SIP messages contain data identifying at least one current network characteristic. The method further includes determining whether a handoff trigger for the mobile device is detected using the current network characteristic.

Other features of the present invention will be apparent from the accompanying drawings and from the detailed description that follows.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a network architecture that provides seamless mobility for end-users.

FIGS. 2-4 illustrate various exemplary network architectures in which embodiments of the present invention may operate.

FIG. 5 is a block diagram of one embodiment of a client mobility module.

FIG. 6 is a flow diagram of one embodiment of a process for providing mobility data.

FIG. 7 is a block diagram of one embodiment of a server mobility module.

FIG. 8 is a flow diagram of one embodiment of a process for performing a handoff from a WiFi network to a cellular network.

FIG. 9 is a flow diagram of one embodiment of a process for updating the HLR.

FIG. 10 is a block diagram of an exemplary computer system.

### DETAILED DESCRIPTION OF THE PRESENT INVENTION

A method and apparatus of handoff decision making for heterogeneous network environments are described. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Overview

Embodiments of the present invention are directed to providing seamless mobility to users of portable devices. Portable devices referred to herein are dual mode mobile devices that allow for interoperability between a wireless local area network (WLAN) and a cellular wide area network (cellular WAN).

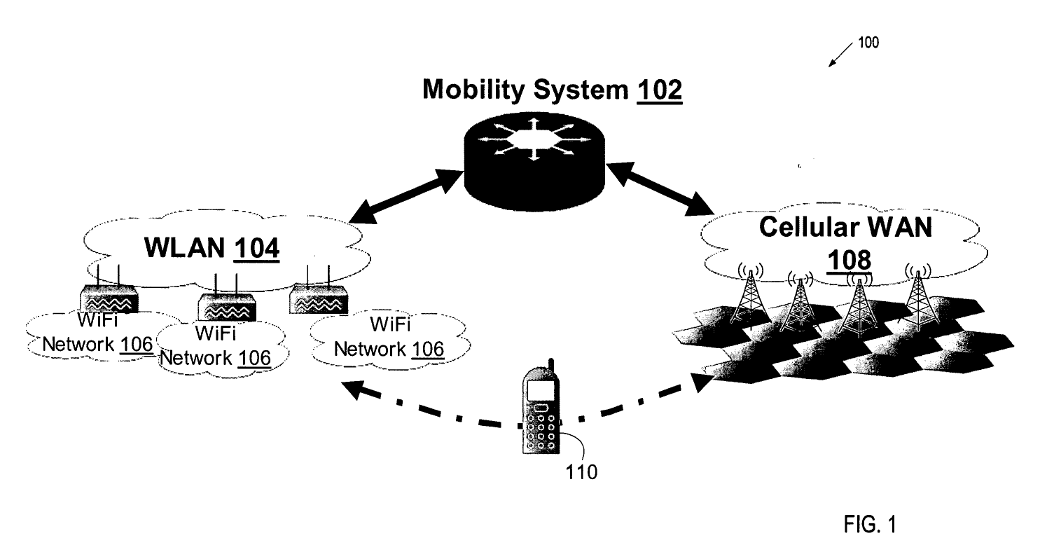

FIG. 1 is a block diagram of one embodiment of a network architecture 100 that provides seamless mobility to end-users.

Referring to FIG. 1, a mobile (or portable) device 110 is coupled to a cellular WAN 108 and a WLAN 104. The mobile device 110 may be a wireless telephone, a pager, a personal digital assistant (PDA), or any other Internet-capable portable device. The cellular WAN (also referred to herein as a cellular network) 104 may be a conventional global system for mobile communications (GSM) network that provides cellular services to end-users. The WLAN 104 may include multiple local area networks known as WiFi networks or IEEE 802.11networks.

A mobility system 102 is coupled to the WLAN 104 and the cellular network 108 to provide seamless session mobility and handoffs between WiFi networks 106 and the cellular network 108 for the mobile device 110.

In one embodiment, the mobility system 102 allows a WiFi network 106 to provide service to the mobile device 110 as long as the quality of service is likely to be acceptable. If the quality of service degrades below an acceptable level, the mobility system 102 executes a seamless handoff from the WiFi network 106 to the cellular network 108.

In one embodiment, the mobility system 102 detects handoff triggers based on current network characteristics provided by the mobile device 110. In one embodiment, the mobile device 110 measures current characteristics of the WiFi network 106 and sends them to the mobile system 102. The characteristics may include, for example, a signal strength indicator, an error rate, a signal quality indicator, etc. As will be discussed in more detail below, the mobile device 110 includes the characteristics of the WiFi network 106 into a session initiation protocol (SIP) message.

While receiving services from the WiFi network 106, the mobile device 110 may also be connected to the cellular network 108. Then, the mobile device 110 can measure characteristics of the cellular network 108 and include them in the SIP messages sent to the mobile system 102.

The mobility system 102 uses data received from the mobile devices to ensure that end-users are served by the network access method that provides them with sufficient signal quality in a transparent manner.

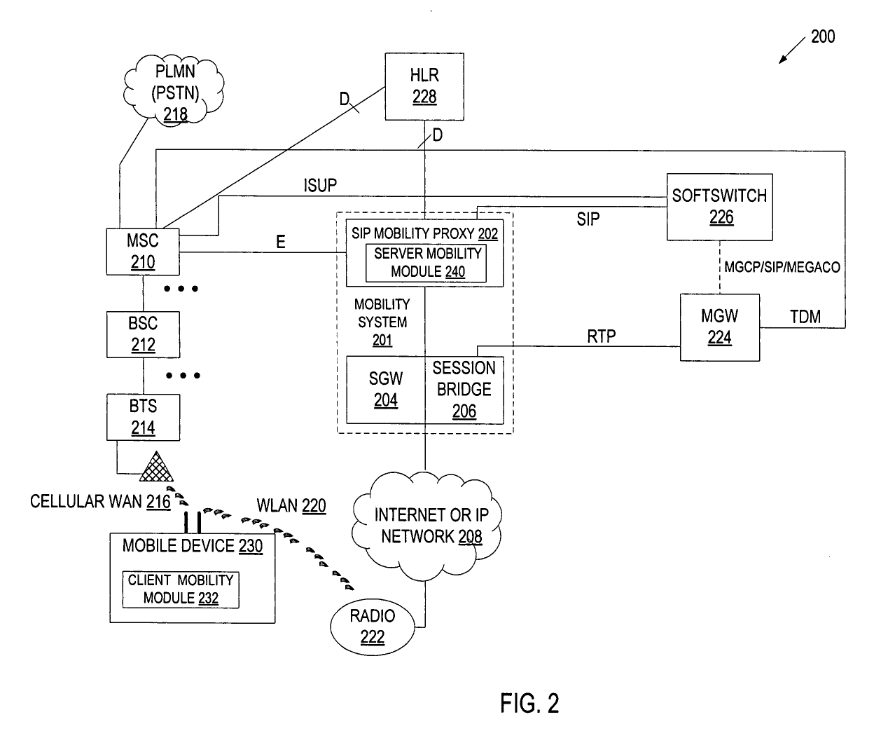

FIGS. 2-4 illustrate various exemplary network architectures in which embodiments of the present invention may operate.

Referring to FIG. 2, the network architecture 200 enables provisioning of public WLAN access service for cellular network subscribers. The cellular network 216 includes at least one MSC 210 that provides a connection of signaling information between a mobile device 230 and a public land mobile network (PLMN) 218 such as a public switched telephone network (PSTN). The MSC 210 communicates with at least one base station controller (BSC) 212, which, in turn, is in contact with at least one base transceiver station (BTS) 214. BTS 214 is a radio tower that provides radio coverage to a cell for which it is responsible. The MSC 210 receives location-updating messages from the mobile device 2310 and sends corresponding update location messages to a home location register (HLR) 228 that maintains subscriber data.

The WLAN 200 includes a radio source 222 coupled to a mobility system 201 via the Internet or IP network 208. The mobility system 201 includes a SIP mobility proxy 202, a signaling gateway (SGW) 204 and a session bridge 206. The mobility system 210 may also include various other components not shown in FIG. 2. The SGW 204 passes SIP messages received from the mobile device 230 to the SIP mobility proxy 202. The session bridge 206 transmits voice data received from the mobile device 230 to a media gateway 224 using the real-time transport protocol (RTP). The media gateway 224 translates the RTP data into time division multiplexing (TDM) data streams and transfers these data streams to the MSC 210.

The SIP mobility proxy 202 provides media session control and signaling relay capability. It relays SIP call-origination requests for a PSTN-destined number to a soft switch 226. The soft switch 226 processes the SIP request, performs digit-translation, applies call-routing, maps the SIP message to ISUP (ISDN user part), and sets up a circuit between the media gateway 224 and the PSTN 218 using ISUP procedures. The soft switch 226 also maps incoming ISUP messages from the PSTN 218 into SIP and forwards the SIP messages to the SIP mobility proxy 202 to set up the RTP packet stream between the media gateway 224 and the mobile device 230. The SIP mobility proxy 202 then relays the SIP message to the mobile device 230. Through SIP message exchanges, the RTP packet stream is established between the mobile device 230 and the MGW 224. The MGW 224 bridges the call onto the TDM circuit set up via ISUP by the soft switch 226.

Once the session is originated, the SIP mobility proxy 202 controls the delivery of the session to the mobile device 230. In one embodiment, the SIP mobility proxy 202 associates incoming SIP requests to an IP address of the mobile device 230 to enable the delivery of the session to the mobile device 230. The SIP mobility proxy 202 relays SIP messages to the mobile device 230 from the soft switch 226 that sets up the RTP packet flow between the mobile device 230 and the MGW 224. When the RTP packet flow takes place, the MGW 224 converts RTP to TDM and sends the resulting data over the previously set up ISUP circuit. The conversation then starts and the session is delivered to the mobile device 230 from the PSTN 218. In one embodiment, the SIP mobility proxy 202 includes a server-based mobility module 240 that is responsible for receiving SIP messages from the mobile device 230 and detecting handoff triggers based on data included in the SIP messages. When a handoff trigger is detected, the mobility module 240 executes a handoff from the WLAN 220 to the cellular network 216. During the handoff execution, the SIP mobility proxy 202 communicates with the MSC 210 via a signaling interface such as the E-Interface. The E-interface as defined by GSM specifications is the signaling interface between two neighboring MSCs. In one embodiment, when communicating with the MSC 210 via the E-Interface, the SIP mobility proxy 202 appears to the MSC 210 as a neighboring MSC. In particular, during a handoff from the WLAN 220 to the cellular network 216, the mobility proxy 202 operates as an initiating MSC that uses the MSC 210 as a target base station subsystem (BSS). In one embodiment, the signaling taking place between the SIP mobility proxy 202 and the MSC 210 over the E-interface is based on GSM-MAP (management application part). BSSMAP messages relevant to handoff events are encapsulated within GSM-MAP messages for transport over the E-interface between the SIP mobility proxy 202 and the MSC 210. During a handoff from the WLAN 220 to the cellular network 216, the SIP mobility proxy 202 initiates and drives a subset of the BSSMAP procedures towards the MSC 210 that controls them towards its BSS.

In one embodiment, the mobility module 240 is also responsible for updating the HLR 228 based on location information included in the SIP messages received from the mobile device 230.

In one embodiment, the mobile device 230 includes a client-based mobility module 232 that composes messages including current network parameters and/or location information for the mobile device 230, and transmits the messages to a network currently providing service to the mobile device 230. In particular, if the mobile device 230 is currently receiving service from the cellular network 216, the mobility module 232 creates GSM messages and transmits them to the MSC 210 over the cellular network 216. Alternatively, if the mobile device 230 is currently receiving service from the WLAN 220, the mobility module 232 creates SIP messages and transmits them to the SIP mobility proxy 202 over the WLAN 220.

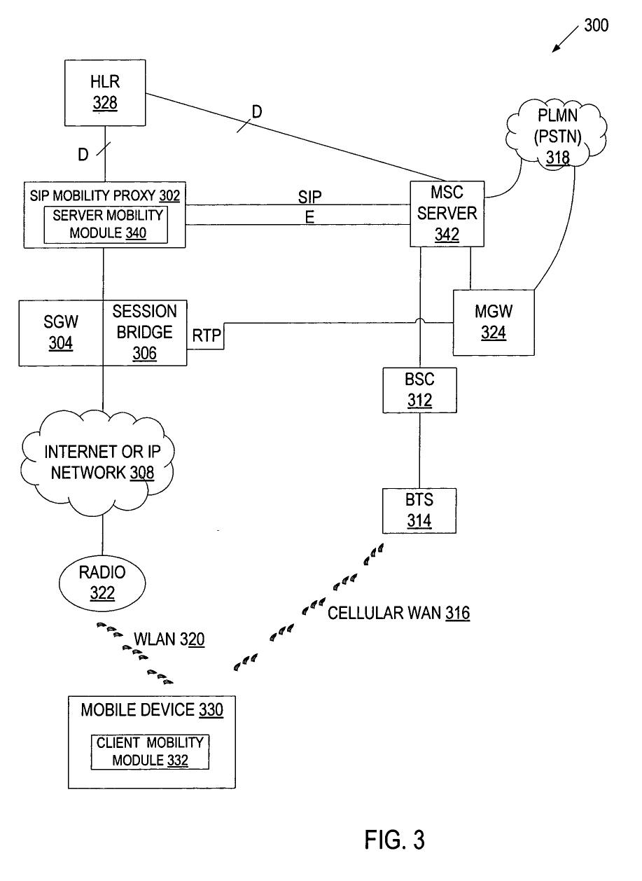

FIG. 3 illustrates an example of an alternative network architecture 300, in which the MSC 210 and the soft switch 226 are replaced with an MSC server 342. The MSC server 342 is IP enabled and as such can perform the functionality of both the MSC and the soft switch.

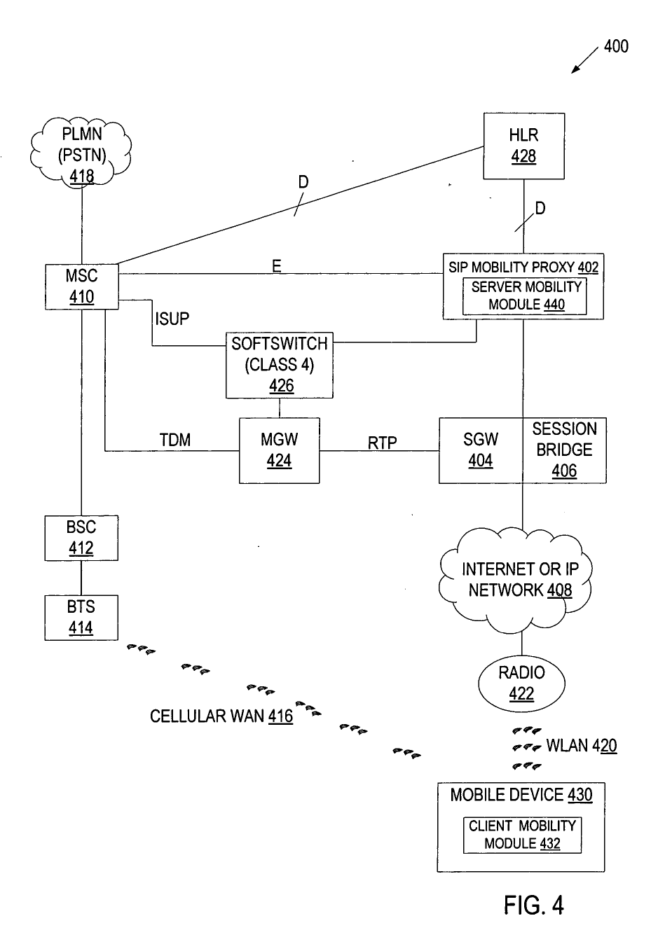

FIG. 4 illustrates an example of yet another network architecture 400 that has similar components but a different configuration than the network architecture 200 of FIG. 2.

Use of SIP Messages for Location Services

The Session Initiation Protocol (SIP) is an application-layer control signaling protocol for creating, modifying and terminating sessions with one or more participants. Members in a session can communicate via multicast or via a mesh of unicast relations, or a combination of these. SIP supports user mobility by proxying and redirecting requests to the user's current location. Users can register their current location. SIP is designed to be independent of the lower-layer transport protocol and can be extended with additional capabilities. A SIP message may have multiple header fields including some mandatory header fields (e.g., a via field, a call-id field, a from field, etc.) and optional header fields (e.g., a contact field, an encryption field, a route field, etc.). A content-type header field is needed only if the message includes a body. The content-type header field indicates the media type of the message body sent to the recipient. Examples of the media-type header field are as follows:
Content-Type: application/sdp
Content-Type: text/html; charset=ISO-8859-4

A content-length header field indicates the size of the message-body sent to the recipient. Applications use this header field to indicate the size of the message-body to be transferred.

The SIP standard (defined in the RFC 2543) allows a SIP message to include multiple bodies (also known as attachments) of various types. In one embodiment, a designated content type (e.g., “Content-Type: application/mobility”) is defined to refer to a body attachment carrying mobile device data. The mobile device data may include, for example, mobile device location data (e.g., SSID, cell ID, access point (AP) ID, etc.), mobile device configuration data (e.g., MAC/L2 address, etc.), network characteristic data (a signal strength indicator, an error rate, etc.), or any combination of the above. In another embodiment, several designated content types may be defined for attachments including different types of mobile device data. For example, one content type may be designated for attachments carrying mobile device location and configuration data (e.g., Content-Type: application/mobility.device), and another content type may be designated for attachments carrying network characteristic data (e.g., Content-Type: application/mobility.network). Yet, in another example, two different attachments may be used to carry WLAN characteristics and cellular network characteristics respectively (e.g., (e.g., Content-Type: application/mobility.WLAN and Content-Type: application/mobility.GSM).

In one embodiment, an additional header field is defined to carry a service set identifier (SSID) for the mobile device. Alternatively, the SSID may be included in the attachment of the message as discussed above.

In one embodiment, the mobile device 230 and the SIP mobility server 202 communicate using SIP messages that have an extended format discussed above.

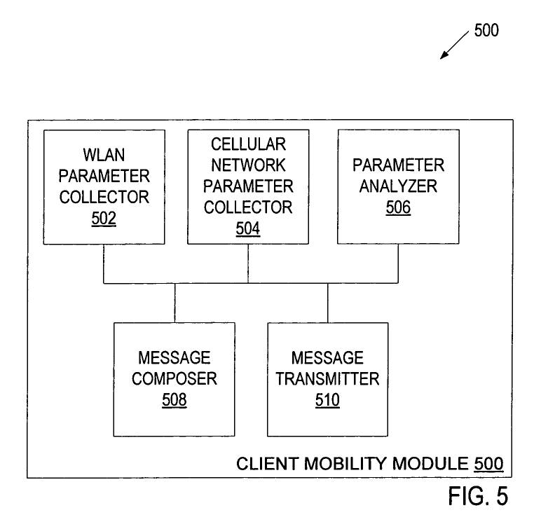

FIG. 5 is a block diagram of one embodiment of a client mobility module 500. The client mobility module 500 includes a WLAN parameter collector 502, a cellular network parameter collector 504, a parameter analyzer 506, a message composer 508, and a message transmitter 510.

The WLAN parameter collector 502 is responsible for measuring current parameters of the WiFi network. The WLAN parameter collector 502 may measure these parameters during an active session and/or roaming. The parameters may include, for example, a signal strength indicator, an error rate, a quality indicator (an estimate of the signal to interference and noise ratio), a currently used radio channel, a list of neighboring APs and their parameters (e.g., AP's signal strength), etc. The WLAN parameter collector 502 may measure these parameters while receiving service from the WiFi network. Alternatively, the WLAN parameter collector 502 may measure these parameters while receiving service from the cellular network and having a simultaneous connection to the WiFi network.

The cellular network parameter collector 504 is responsible for measuring current parameters of the cellular network during an active session and/or roaming. The parameters may include, for example, a signal strength indicator, an error rate, a quality indicator (an estimate of the signal to interference and noise ratio), a currently used radio channel, a channel code, a list of neighboring cells and their parameters (e.g., cell's signal strength, etc.), etc. The cellular network parameter collector 504 may measure these parameters while receiving service from the cellular network. Alternatively, the cellular network parameter collector 504 may measure these parameters while receiving service from the WiFi network and having a simultaneous connection to the cellular network.

The parameter analyzer 506 is responsible for performing thresholding and normalization of the parameters collected by the WLAN parameter collector 502 and/or the cellular network parameter collector 504. Thresholding is performed using thresholds defined by a user of the mobile device or a carrier. If a network characteristic exceeds a predefined threshold, the parameter analyzer 506 invokes the message composer 508 to compose a message.

The message composer 508 adds mobile device location data (e.g., cell ID, SSID, etc.) and mobile device configuration data (e.g., MAC/L2address, etc.) to the network parameters, and performs protocol encapsulation and packaging for the combined data. In one embodiment, if the mobile device is currently receiving WiFi service, the message composer 508 composes a SIP message. Otherwise, if the mobile device is currently receiving service from the cellular network, the message composer 508 composes a GSM message.

During roaming, the message composer 508 composes a registration message including the location of the mobile device. Depending on the network currently providing service to the mobile device, the registration message may be a SIP registration message or a GSM registration message. The SIP registration message contains the IP address of the mobile device. In addition, in one embodiment, the mobile device obtains the MAC address and the SSID of the WiFi AP currently serving the mobile device and adds this information to the SIP registration message. In one embodiment, this information is included in the attachment of the SIP registration message in a manner discussed above.

The message transmitter 510 is responsible for transmitting the message to an appropriate server system. In particular, if the message is a SIP message, the message transmitter 510 transmits this message to a SIP mobility proxy over the WiFi network. Alternatively, if the message is a GSM message, the message transmitter 510 transmits the message to the MSC via the cellular network.

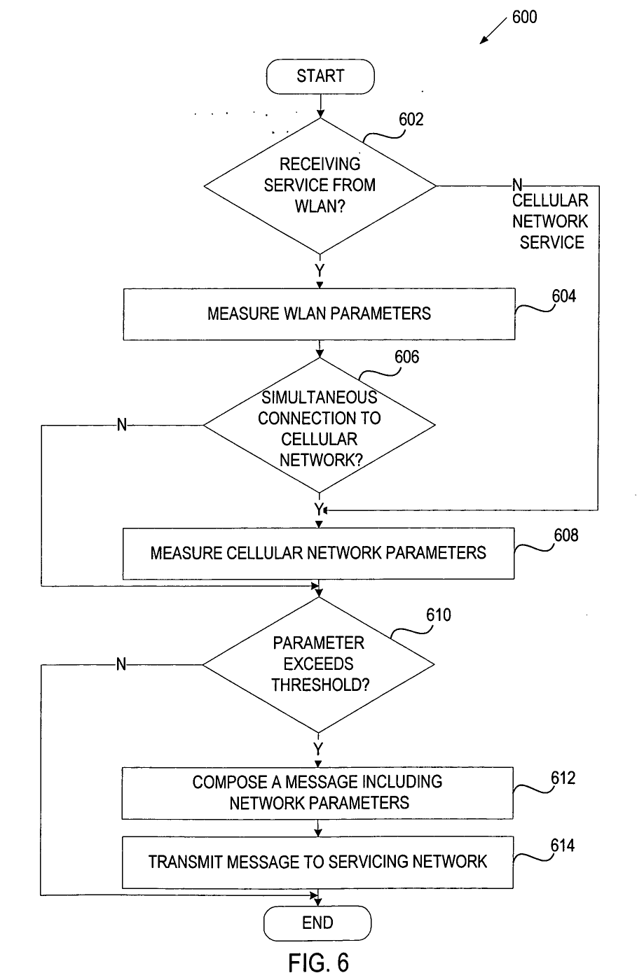

FIG. 6 is a flow diagram of one embodiment of a process 600 for providing mobility data. The process may be performed by processing logic that may comprise hardware (e.g., circuitry, dedicated logic, programmable logic, microcode, etc.), software (such as run on a general purpose computer system or a dedicated machine), or a combination of both. In one embodiment, the process 600 is performed by a client mobility module 232 of FIG. 2.

Referring to FIG. 6, processing logic begins with determining whether the mobile device is receiving service from a WiFi network (processing block 602). If so, processing logic measures parameters of the WiFi network (processing block 604). These parameters may include, for example, a signal strength indicator, an error rate, a quality indicator (an estimate of the signal to interference and noise ratio), a currently used radio channel, a list of neighboring APs and their parameters (e.g., AP's signal strength, etc.), etc.

Next, if the mobile device is also simultaneously connected to the cellular network (processing block 606), processing logic measures parameters of the cellular network (processing block 608). These parameters may include, for example, a signal strength indicator, an error rate, a quality indicator, a currently used radio channel, a channel code, a list of neighboring cells and their parameters (e.g., cell's signal strength), etc.

If the mobile device is currently receiving service from the cellular network, processing logic proceeds directly to processing block 608. In an alternative embodiment, processing logic also measures the WiFi parameters if the mobile device has a simultaneous connection to the WiFi network.

At processing block 610, processing logic determines whether at least one network parameter exceeds a threshold. In one embodiment, a single specific parameter (e.g., an error rate) is compared to a threshold. In another embodiment, two or more threshold parameters (e.g., an error rate, a signal strength indicator, a quality indicator, etc.) are compared with corresponding thresholds to determine whether any of these parameters exceeds a threshold. In yet another embodiment, several parameters are combined to determine whether the combination exceeds a threshold. The thresholds may be defined by a user of the mobile device, a carrier or a device manufacturer.

If the determination made at processing block 610 is negative, process 600 ends. Otherwise, if the determination made at processing block 610 is positive, processing logic composes a message including the network parameters and/or device information. In one embodiment, if the mobile device is currently receiving service from the cellular network, processing logic composes a GSM message. Otherwise, if the mobile device is currently receiving service from the WiFi network, processing logic composes a SIP message. In one embodiment, the SIP message includes an attachment (defined by a specific content-type in a content-type header field) to carry the device information (e.g., device location and configuration information) and the network parameters. In another embodiment, the SIP message includes several attachments (defined in corresponding content-type header fields) to carry the device information (e.g., device location and configuration information) separately from the network parameters. In yet another embodiment, the WiFi network parameters and the cellular network parameters are carried in two different attachments. In one embodiment, the SSID associated with the mobile device is specified in a header field of the SIP message. This header field may be an existing header field (e.g., PLEASE SPECIFY) defined in the SIP standard or an additional header field designated for the SSID. In another embodiment, the SSID is included in the attachment of the SIP message.

At processing block 614, the message composed at processing block 612 is transmitted to the network currently providing service to the mobile device. In particular, the GSM message is transmitted to the cellular network and the SIP message is transmitted to the WiFi network.

Handoff Decision Making for Heterogeneous Network Environments

In one embodiment, mobility events, such as handoffs between the WiFi network and the cellular network, are controlled by the SIP mobility proxy, thus making them transparent to end users.

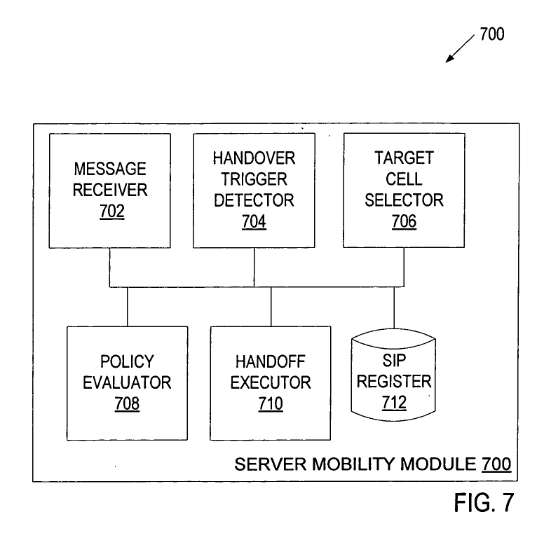

FIG. 7 is a block diagram of one embodiment of a server-based mobility module 700. The mobility module 700 includes a message receiver 702, a handover trigger detector 704, a target cell selector 706, a policy evaluator 708, a handoff executor 710, and a SIP register 712.

The SIP register 712 performs a subset of the Visitor Location Register (VLR) functions. The SIP register 712 stores the session status, user service profiles, and the location of mobile devices and users. The SIP register 712 may appear as a VLR on the GSM side of the network domains. In one embodiment, the SIP register 712 provides routing information to the HLR upon request. The routing information may include the address of the SIP register 712 to be used for routing of GSM messages. In another embodiment, the SIP register 712 performs a subset of Home Location Register (HLR) functions, in addition to the VLR functionality.

The message receiver 702 is responsible for receiving messages from the mobile device. The messages are SIP registration messages transmitted by the mobile device during roaming and SIP messages transmitted by the mobile device during active sessions. The message receiver 702 parses the SIP messages to extract the contact information of the mobile device and refreshes/updates the SIP register 712 with the contact information. The contact information may be stored in a header and/or an attachment of a SIP message. In addition, the message receiver 702 extracts network parameters (e.g., WLAN parameters and cellular network parameters) from the attachment(s) of a SIP message. The attachment may be identified in the content-type header field of a SIP message in a manner discussed above.

The handover trigger detector 704 is responsible for detecting handoff triggers based on one or more WiFi network parameters received from the mobile device. The WiFi network parameters may include, for example, a received signal strength indicator (RSSI), a word error indicator (WEI), a bit error rate also (BER) known as an error rate, a quality indicator (QI), etc. The RSSI is the measure of received signal strength from radio sources. RSSI measurements shall include both uplink and downlink signal strengths. The WEI indicates whether the current signal burst was properly demodulated in the mobile device. The BER is a bit error rate seen on the WiFi air link. The QI is the estimate of the signal to interference and noise ratio, including the effects of dispersion.

A handoff trigger may be based on a single network parameter (e.g., RSSI or BER). Alternatively, a handoff trigger may be based on multiple network parameters (e.g., a combination of RSSI and BER or any other combination of network parameters described above).

The handover trigger detector 704 analyzes and compares the WiFi parameters with pre-determined thresholds established by the carrier in order to make handoff event decisions. In addition, in one embodiment, the handover trigger detector 704 makes handoff decisions based on other handoff criteria such as load balancing, least cost air-link determination and best bandwidth air-link determination. Load balancing provides the ability to initiate handoff upon determination that the WiFi domain is overload and is suffering from traffic congestion. Least cost air-link determination provides the ability to handoff to the air-link that costs the least upon detection of the availability of such an air-link. Best bandwidth air-link determination provides the ability to handoff to the air-link that provides the best available bandwidth for a given session type such as video. In one embodiment, the handover trigger detector 704 may also initiate a handoff event as a response to a MSC's invocation. In one embodiment, in the case of an on-going voice group call, the handoff triggers only apply to the device currently assigned the uplink.

The target cell selector 706 is responsible for selecting a target cell for the handoff. In one embodiment, this selection is based on the location of the mobile device and cellular network parameters provided by the mobile device (e.g., a list of nearby cells and their characteristics such as a signal strength indicator). For example, a nearby cell with the strongest RSSI value may be selected to provide the best air-link for the session. In addition, the target selector 706 determines that a handoff towards the selected target cell site is warranted for this particular media session.

The policy evaluator 708 is responsible for evaluating the selected target cell in view of policies specified by the carrier and/or the subscriber. These policies may specify, for example, security requirements, carrier preferences with respect to cell usage, timing requirements, etc.

The handoff executor 710 is responsible for executing a handoff from the WiFi network to the target cell in the cellular network. In one embodiment, the handoff executor 710 sends a SIP message with the GSM handover command to the mobile device. The GSM handover command may be included in the SIP message as part of the header or attachment in the manner described above. This SIP message may include, for example, a selected cell ID, a target channel ID, etc.

In one embodiment, the handoff executor 710 prepares a HANDOVER REQUEST message that contains such parameters as a target cell ID, a serving cell ID, a channel type, encryption information, and a cause value associated with the reason for this particular handoff event. The handoff executor 710 may encapsulate the HANDOVER REQUEST message in a MAP PREPARE HANDOVER REQUEST message and forward the MAP PREPARE HANDOVER REQUEST message to the GSM MSC (e.g., MSC 210 of FIG. 2) using the E-Interface. The MSC may then request its VLR to assign a handover reference number for this particular handoff event and forward the HANDOVER REQUEST message encapsulated in the MAP PREPARE HANDOVER REQUEST message to its BSS (e.g., BSS 212 of FIG. 2), requesting the BSS to allocate a circuit channel on the cell site indicated as the target handoff candidate within the HANOOVER REQUEST message. The BSS then proceeds to allocate a circuit channel at the target cell site and responds with a HANDOVER REQUEST ACK message to the MSC that contains the chosen channel's information. The MSC encapsulates the HANDOVER REQUEST ACK message in a MAP PREPARE HANDOVER Response message and forwards it to the handoff executor 710.

In one embodiment, upon receipt of the MAP PREPARE HANDOVER Response message, the handoff executor 710 initiates voice bearer transfer from the MGW (e.g., MGW 224 of FIG. 2) to the MSC and requests the soft switch (e.g., soft switch 226 of FIG. 2) to set up the voice bearer transfer to the MSC. In addition, the handoff executor 710 instructs the MGW to transfer the voice bearer towards the MSC. While the voice bearer transfer signaling is taking place, the handoff executor 710 may formulate a HANDOVER COMMAND message and send it to the mobile device. This message may be a SIP message containing in its attachment a target cell ID, a handover reference number, and the body of the HANDOVER REQUEST ACK message received from the MSC. Then, the mobile device may proceed to lock onto the assigned circuit-channel at the identified target cell site. When synchronized, the mobile device will send a HANDOVER ACCESS message to the BSS containing the handover reference number. The BSS may use the handover reference number to correlate the mobile device with the handoff event. The BSS will then send a HANDOVER DETECT message to the MSC which encapsulates it in a MAP PROCESS ACCESS SIGNALING Request message and sends it to the handoff executor 710. Next, the mobile device sends a HANDOVER COMPLETE message to the MSC via the BSS. The MSC will proceed to encapsulate this message in a MAP SEND END SIGNAL message to the handoff executor 710. At this point, the voice transfer starts and the session has been handed over from the WiFi network to the GSM domain.

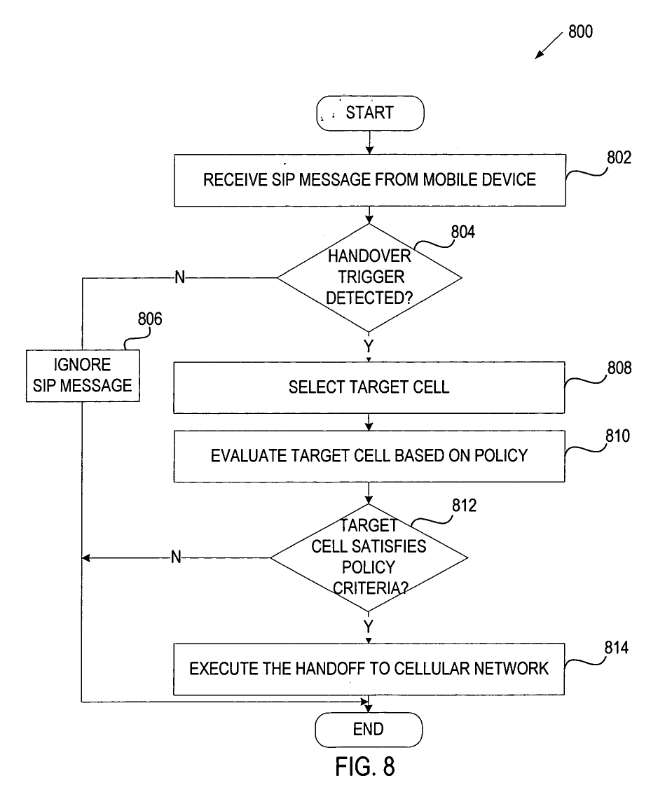

FIG. 8 is a flow diagram of one embodiment of a process 800 for performing a handoff from a WiFi network to a cellular network. The process may be performed by processing logic that may comprise hardware (e.g., circuitry, dedicated logic, programmable logic, microcode, etc.), software (such as run on a general purpose computer system or a dedicated machine), or a combination of both. In one embodiment, the process 800 is performed by a server mobility module 240 of FIG. 2.

Referring to FIG. 8, processing logic begins with receiving a SIP message from a mobile device during an active session (processing block 802). The SIP message may include one or more attachments carrying mobile device data, such as location data (e.g., cell ID, SSID, etc.) and configuration data (e.g., MAC/L2address, etc.), and current network parameters. The current network parameters may include parameters of the WiFi network (e.g., RSSI, WEI, QI, BER, a list of nearby APs and their parameters, etc.) and parameters of the cellular network (e.g., a list of nearby cells and their parameters such as RSSI, WEI and QI).

At processing block 804, processing logic determines whether a handover trigger is detected. As discussed above, a handoff trigger may be based on a single network parameter (e.g., RSSI or BER). Alternatively, a handoff trigger may be based on multiple network parameters (e.g., a combination of RSSI and BER or any other combination of network parameters described above). Processing logic performs handover trigger detection by analyzing and comparing the WiFi parameters with pre-determined thresholds. In addition, in one embodiment, processing logic considers other handoff criteria such as load balancing, least cost air-link determination and best bandwidth air-link determination.

If no handover trigger is detected, processing logic ignores the SIP message (processing block 806). Alternatively, processing logic selects a target cell for the handover (processing block 808). In one embodiment, processing logic selects a target cell based on the location of the mobile device and cellular network parameters provided by the mobile device (e.g., a list of nearby cells and their characteristics such as RSSI).

At processing block 812, processing logic evaluates the selected target cell based on predefined policies. These policies may specify, for example, security requirements, carrier preferences with respect to cell usage, timing requirements, etc. If the target cell does not satisfy policy requirements, process 800 ends. Otherwise, processing logic executes a handoff from the WiFi network to the target cell in the cellular network (processing block 814).

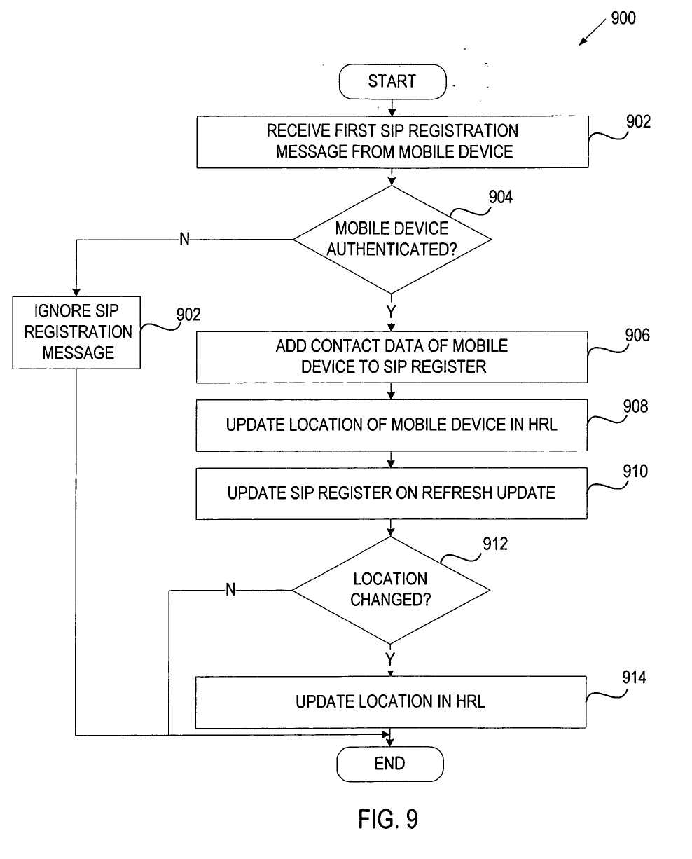

FIG. 9 is a flow diagram of one embodiment of a process 900 for updating the HLR. The process may be performed by processing logic that may comprise hardware (e.g., circuitry, dedicated logic, programmable logic, microcode, etc.), software (such as run on a general purpose computer system or a dedicated machine), or a combination of both. In one embodiment, the process 800 is performed by a server mobility module 240 of FIG. 2.

Referring to FIG. 9, processing logic begins with receiving a first SIP registration message from a mobile device during roaming and authenticating the mobile device based on the SIP registration message (processing block 902). If the mobile device does not pass authentication (processing block 904), the SIP registration message is ignored (processing block 916). Otherwise, processing logic extracts the mobile device's contact data (e.g., SSIP, MAC address, AP ID, etc.) and adds it to a SIP register (processing block 906). In one embodiment, the SIP register performs a subset of the VLR finctions. The SIP register stores the session status, user service profiles, and the location of mobile devices and users. The SIP register may appear as a VLR on the GSM side of the network domains.

At processing block 908, processing logic updates the location of the mobile device in the HLR based on the location data from the SIP registration message.

Subsequently, the mobile device may periodically send SIP registration messages to refresh the registration. In addition, the mobile device may send SIP messages when its location information changes. Processing logic receives these messages and updates the SIP register on refresh and update (processing block 910). If the location of the mobile device has changed (processing block 912), processing logic updates the HLR with the new location (processing block 914).

An Exemplary Computer System

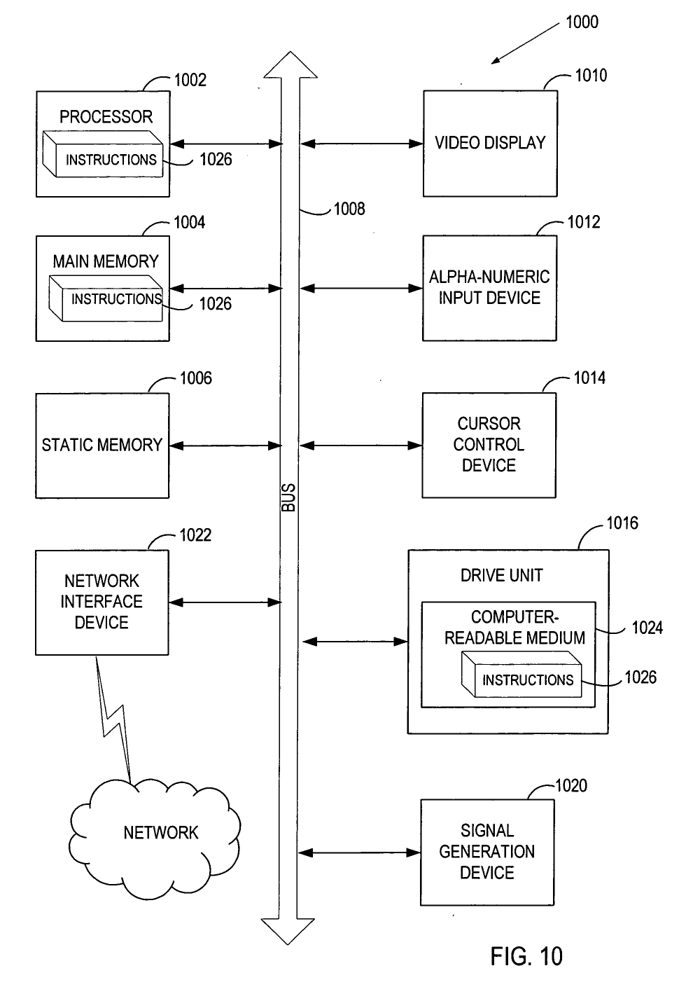

FIG. 10 is a block diagram of an exemplary computer system 1000 that may be used to perform one or more of the operations described herein. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1000 includes a processor 1002, a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alpha-numeric input device 1012 (e.g., a keyboard), a cursor control device 1014 (e.g., a mouse), a disk drive unit 1016, a signal generation device 1020 (e.g., a speaker) and a network interface device 1022.

The disk drive unit 1016 includes a computer-readable medium 1024 on which is stored a set of instructions (i.e., software) 1026 embodying any one, or all, of the methodologies described above. The software 1026 is also shown to reside, completely or at least partially, within the main memory 1004 and/or within the processor 1002. The software 1026 may further be transmitted or received via the network interface device 1022. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to included, but not be limited to, solid-state memories, optical and magnetic disks, and carrier wave signals.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
receiving session initiation protocol (SIP) messages via a wireless local area network (WLAN), the SIP messages comprising data identifying at least one current network characteristic; and
determining whether a handoff trigger for a mobile device is detected using the at least one current network characteristic.

2. The method of claim 1 wherein determining whether the handoff trigger is detected comprises:
comparing the at least one current network characteristic with a threshold.

3. The method of claim 2 wherein the threshold is defined by a carrier.

4. The method of claim 1 wherein determining whether the handoff trigger is detected comprises:
determining whether a wireless local area network (WLAN) providing service to the mobile device is overloaded.

5. The method of claim 1 wherein determining whether the handoff trigger is detected comprises:
determining whether a cell with desired parameters is available in a cellular wide area network (WAN).

6. The method of claim 1 wherein the at least one current network characteristic comprises at least one of a signal strength indicator and an error rate.

7. The method of claim 1 firther comprising:
selecting a target cell to serve the mobile device.

8. The method of claim 7 wherein the target cell is selected based on a mobile device location and characteristics of nearby cells.

9. The method of claim 7 further comprising:
evaluating the target cell based on policy criteria; and
executing a handover from the WLAN to a cellular wide area network (WAN) if the target cell meets the policy criteria.

10. The method of claim 9 wherein the handover policy criteria comprises at least one of a security criterion, a carrier preference and a timing criterion.

11. The method of claim 1 wherein the at least one current network characteristic is included in an attachment of a SIP message.

12. The method of claim 11 wherein a type of the attachment is specified in one of a plurality of header fields of the SIP message.

13. The method of claim 1 further comprising:
receiving a registration message from the mobile device in a roaming mode, the registration message comprising contact information for the mobile device; and
storing the contact information in a SIP register.

14. The method of claim 13 further comprising:
determining, based on the contact information, that a location of the mobile device has changed; and
updating the location of the mobile device in a home location register (HLR).

15. The method of claim 13 wherein the registration message comprises a SIP registration message.

16. An apparatus comprising:
a message receiver to receive session initiation protocol (SIP) messages via a wireless local area network (WLAN), the SIP messages comprising data identifying at least one current network characteristic; and
a handover trigger detector to determine whether a handoff trigger for a mobile device is detected using the at least one current network characteristic.

17. The apparatus of claim 16 wherein the handover trigger determines whether the handoff trigger is detected by comparing the at least one current network characteristic with a threshold.

18. The apparatus of claim 17 wherein the threshold is defined by a carrier.

19. The apparatus of claim 16 wherein the handover trigger determines whether the handoff trigger is detected by determining whether a wireless local area network (WLAN) providing service to the mobile device is overloaded.

20. The apparatus of claim 16 wherein the handover trigger determines whether the handoff trigger is detected by determining whether a cell with desired parameters is available in a cellular wide area network (WAN).

21. The apparatus of claim 16 wherein the at least one current network characteristic comprises at least one of a signal strength indicator and an error rate.

22. The apparatus of claim 16 further comprising a target cell selector to select a target cell to serve the mobile device.

23. The apparatus of claim 16 wherein the at least one current network characteristic is included in an attachment of a SIP message.

24. The apparatus of claim 23 wherein a type of the attachment is specified in one of a plurality of header fields of the SIP message.

25. A system comprising:
means for receiving session initiation protocol (SIP) messages via a wireless local area network (WLAN), the SIP messages comprising data identifying at least one current network characteristic; and
means for determining whether a handoff trigger for a mobile device is detected using the at least one current network characteristic.

26. A computer readable medium comprising executable instructions which when executed on a processing system cause said processing system to perform a method comprising:
receiving session initiation protocol (SIP) messages via a wireless local area network (WLAN), the SIP messages comprising data identifying at least one current network characteristic; and
determining whether a handoff trigger for a mobile device is detected using the at least one current network characteristic.
